(19) United States
(12) Patent Application Publication
(10) Pub. No.: US 2017/0189866 A1
(43) Pub. Date: Jul. 6, 2017

(54) Mixed Matrix Hollow Fiber Membranes

(71) Applicant: Georgia Tech Research Corporation, Atlanta, GA (US)

(72) Inventors: William John Koros, Atlanta, GA (US); Chen Zhang, Atlanta, GA (US)

(21) Appl. No.: 15/313,121

(22) PCT Filed: May 26, 2015
(86) PCT No.: PCT/US15/32479

§ 371 Date: Nov. 22, 2016

Related U.S. Application Data
(60) Provisional application No. 62/002,811, filed on May 24, 2014.

(51) Int. Cl. B01D 71/64; B01D 69/08; B01D 69/12; B01D 71/56; C08G 73/10; B29C 47/06; B29C 47/08; D01D 1/02; D01D 5/24; D01F 6/74; B01D 69/14; B29C 47/00

(52) U.S. Cl. CPC B01D 71/64; B01D 69/148; B01D 69/088; B01D 69/12; B01D 71/56; B29C 47/0004; B29C 47/0014; B29C 47/065; B29C 47/081; D01D 1/02; D01D 5/24; D01F 6/74; C08G 73/1067; B01D 2325/04; B01D 2325/02; B29K 2079/085

(57) ABSTRACT

Provided herein are metal organic framework/polymer mixed-matrix hollow fiber membranes and metal organic framework/carbon molecular sieve mixed-matrix hollow fiber membranes. The materials have high MOF particle loading and are easily scalable. The MOF/polymer mixed-matrix hollow fibers are formed using a dry-jet/wet-quench fiber spinning technique and show C₃H₆/C₃H₈ selectivity that is significantly enhanced over the pure polymer fiber and that is consistent with the selectivity of mixed-matrix dense films of the same MOF/polymer combination. The MOF/CMS mixed-matrix hollow fibers are formed by pyrolyzing the MOF/polymer mixed-matrix hollow fibers and show increased C₃H₆ permeance and increased selectivity over the MOF/polymer mixed-matrix hollow fiber membranes.

### BACKGROUND

Permselective membranes are attractive as energy-efficient separation devices to either retrofit or replace conventional, energy-intensive gas separation processes such as cryogenic distillation and amine-absorption. The separation of propylene from propylene/propane (C₃H₆/C₃H₈) mixtures is traditionally achieved by fractional distillation, which is extremely energy-intensive due to close volatilities of C₃H₆ and C₃H₈. The separation of C₃H₆/C₃H₈ is one of the largest energy consumers in the petrochemical industry.

Polymer membranes with excellent scalability are available for air separation, hydrogen recovery and natural gas purification; however, polymer membranes have not been successfully extended to olefin/paraffin separations. Pure polymeric membranes are relatively inexpensive and easy to scale up; however, the C₃H₆/C₃H₈ selectivity of pure polymeric material does not meet the required selectivity standards. Also, pure polymeric materials suffer from the well-known upper bound trade-off curve for C₃H₆/C₃H₈ separation, which means that high permeability and high selectivity cannot be achieved at the same time.

Mixed-matrix membranes formed by dispersing highly selective molecular sieve particles in a polymer matrix combine the ease of processing polymeric membranes with the superior separation performance of molecular sieving materials. With the appropriate choice of polymer and molecular sieve, mixed matrix membranes may overcome the upper bound of pure polymeric materials and become attractive for industrial applications.

The majority of published research on mixed-matrix membranes is focused on membrane materials and film fabrication at a small scale. Such small scale materials have little or no potential for commercial industrial applications. There remains a need for materials for separating various components where the materials have high separation efficiencies and are also scalable. Disclosed herein are mixed-matrix materials and methods of forming those materials as asymmetric hollow fibers. The materials and methods described herein have high separation efficiencies, are easily scalable, and have potential as commercially viable devices and methods for large-scale gas separations.

### SUMMARY

Provided herein are dual-layer metal organic framework (MOF)/polymer mixed-matrix hollow fiber membranes. The materials have high MOF particle loading and are easily scalable. The mixed-matrix hollow fibers are formed using a dry-jet/wet-quench fiber spinning technique and show C₃H₆/C₃H₈ selectivity that is significantly enhanced over the pure polymer fiber and that is consistent with the selectivity of mixed-matrix dense films of the same MOF/polymer combination.

The materials provided herein include a hollow fiber including a sheath layer, wherein the sheath layer includes a plurality of metal organic framework (MOF) particles dispersed in a first polymer; and a core layer adjacent to and radially inward from the sheath layer, wherein the core layer comprises a second polymer. Optionally, the first and second polymers are the same polymer. Optionally, the first and second polymers are different polymers. Optionally, the first polymer includes a polyimide (e.g., 2,2-bis (3,4-carboxyphenyl) hexafluoropropane dianhydride-diaminomesitylene (6FDA-DAM), 6FDA/BPDA-DAM, 6FDA-DAM/DABA, 6FDA-6FpDA, 6FDA-durene, Matrimid®, or P84®), a polyamide-imide (e.g., Torlon®), a polyetherimide (e.g. Ultem®), or a cellulose acetate. Optionally, the second polymer includes a polyimide (e.g., 2,2-bis (3,4-carboxyphenyl) hexafluoropropane dianhydride-diaminomesitylene (6FDA-DAM), 6FDA/BPDA-DAM, 6FDA-DAM/DABA, 6FDA-6FpDA, 6FDA-durene, Matrimid®, or P84®), a polyamide-imide (e.g., Torlon®), a polyetherimide (e.g. Ultem®), or a cellulose acetate.

Optionally, the MOF particles include zeolitic imidazolate framework (ZIF) particles (e.g., ZIF-7, ZIF-8, ZIF-9, ZIF 90, and hybrid ZIF's including a mixture of two or more imidazolate ligands of the above pure ZIF's). The MOF (or ZIF) particles optionally are nanoparticles. Optionally the MOF (or ZIF) particles are present in the sheath layer in an amount of at least 16% by weight (e.g., at least 20% by weight). Optionally, the core layer is substantially free of MOF (or ZIF) particles.

Optionally, the sheath layer has a thickness of less than about 5 micron (e.g., from about 1 to about 5 micron). Optionally, the fiber has an outer diameter equal to or less than about 300 micron (e.g., from about 150 to about 300 micron).

Also provided herein is a MOF/carbon molecular sieve (CMS) mixed-matrix hollow fiber membrane. The MOF/CMS mixed-matrix hollow fiber membrane includes a sheath layer including a plurality of MOF particles dispersed in a first CMS including a first plurality of pores; and a core layer adjacent to and radially inward from the sheath layer, wherein the core layer includes a second CMS including a second plurality of pores. Optionally the first and second CMSs are substantially the same in chemical composition. Optionally, the first and second CMSs include disordered hexagonal carbon sheets. Optionally, the first plurality of pores and the second plurality of pores are of substantially the same size. Optionally, the first plurality of pores has an average pore size greater than the average pore size of the second plurality of pores. Optionally, the first plurality of pores has an average pore size less than the average pore size of the second plurality of pores.

Optionally, the MOF particles include zeolitic imidazolate framework (ZIF) particles (e.g., ZIF-7, ZIF-8, ZIF-9, ZIF 90, and hybrid ZIF's including a mixture of two or more imidazolate ligands of the above pure ZIF's). The MOF (or ZIF) particles optionally are nanoparticles. Optionally the MOF (or ZIF) particles are present in the sheath layer in an amount of at least 16% by weight (e.g., at least 20% by weight). Optionally, the core layer is substantially free of MOF (or ZIF) particles.

Optionally, the sheath layer has a thickness of less than about 5 micron (e.g., from about 1 to about 5 micron). Optionally, the fiber has an outer diameter equal to or less than about 300 micron (e.g., from about 150 to about 300 micron).

Also provided herein are methods of forming the MOF/polymer mixed-matrix hollow fibers. The methods include combining a first polymer, a plurality of MOF particles, and one or more solvents to form a sheath dope; combining a second polymer and one or more solvents to form a core dope; and co-extruding the sheath dope, the core dope, and a bore fluid through a spinneret to form a hollow fiber. Optionally the MOF particles are not dried prior to the step of forming the sheath dope. Optionally the step of combining the first polymer, the plurality of MOF particles, and one or more solvents to form a sheath dope includes dissolving a first portion of the first polymer in a first portion of a first solvent to form dope A; combining MOF particles with a second portion of the first solvent to form a MOF/solvent slurry; adding dope A to the MOF/solvent slurry to form dope B; adding a second portion of the first polymer to dope B to form a paste; adding a second solvent to the paste to form dope C; adding a third portion of the first polymer to dope C to form the sheath dope. Optionally, the MOF particles are not dried prior to the step of forming the MOF/solvent slurry.

Optionally, the MOF particles include ZIF particles (e.g., ZIF-7, ZIF-8, ZIF-9, ZIF 90, and hybrid ZIF's including a mixture of two or more imidazolate ligands of the above pure ZIF's). The MOF (or ZIF) particles optionally are nanoparticles. Optionally the MOF (or ZIF) particles are present in the sheath dope in an amount of about 5 to about 9% by weight. Optionally, the core dope is substantially free of MOF (or ZIF) particles.

Optionally, the first and second polymers are the same. Optionally, the first and second polymers are different. Optionally, the first polymer includes a polyimide (e.g., 6FDA-DAM, 6FDA/BPDA-DAM, 6FDA-DAM/DABA, 6FDA-6FpDA, 6FDA-durene, Matrimid®, or P84®), a polyamide-imide (e.g., Torlon®), a polyetherimide (e.g. Ultem®), or a cellulose acetate). Optionally, the concentration of the first polymer in the sheath dope is about 20 to about 26% by weight. Optionally the second polymer is a polyimide (e.g., 6FDA-DAM, 6FDA/BPDA-DAM, 6FDA-DAM/DABA, 6FDA-6FpDA, 6FDA-durene, Matrimid®, or P84®), a polyamide-imide (e.g., Torlon®), a polyetherimide (e.g. Ultem®), or a cellulose acetate). Optionally, the core dope further comprises lithium nitrate and the sheath dope does not comprise lithium nitrate.

Optionally, the methods further include a step of coating the hollow fiber with a third polymer. Optionally, the third polymer includes a polyaramid, a polydimethylsiloxane, or a polyaramid/polydimethylsiloxane mixture. Optionally the methods further include a step of quenching the hollow fiber in a water bath at a temperature of from 12 to 50 degrees C. (e.g., from 12 to 25 degrees C.).

Also provided herein are methods of forming the MOF/CMS mixed-matrix hollow fibers. A MOF/polymer mixed-matrix hollow fiber is heated to a final pyrolysis temperature (e.g., about 450° C. to about 650° C., or about 500° C. to about 600° C.). The fiber is then heated at the final pyrolysis temperature (e.g., about 450° C. to about 650° C., or about 500° C. to about 600° C.) for one minute to twelve hours (e.g., for about 2 hours to about 4 hours) and then cooled to about room temperature (about 19° C. to about 24° C.). The entire pyrolysis process is carried out under inert gas (e.g., argon or nitrogen). The flow rate of the inert gas is within a range of one to 500 cubic centimeters per minute. Optionally, the fiber starts the process at about room temperature (e.g., at about 19° C. to about 24° C.). Optionally, the fiber starts the process at a temperature higher than room temperature. Optionally, the step of heating to the final pyrolysis temperature may be a one-step process. Optionally, the step of heating to the final pyrolysis temperature may be a multi-step process, wherein each step includes heating at a different rate (e.g., at least two steps, wherein the heating rate is faster during the first step than during the second step, or at least three steps wherein the heating rate is faster during the first step than during the second step and faster during the second step than during the third step).

Also provided herein are methods of separating a first component from a second component of a multicomponent mixture using membranes comprising any material described herein. Optionally, the first component comprises propylene and the second component comprises propane. Optionally, the first component comprises carbon dioxide and the second component comprises methane. Optionally, the first component comprises oxygen and the second component comprises nitrogen. Optionally, the first component comprises ethylene and the second component comprises ethane. Optionally, the first component comprises n-butane and the second component comprises iso-butane.

### BRIEF DESCRIPTION OF DRAWINGS

FIG. 1 is a schematic of a dual-layer, mixed-matrix hollow fiber consistent with the present disclosure.

FIG. 2 A-I through C-IV are SEM images of hollow fiber membranes including a neat hollow fiber membrane and dual layer mixed-matrix hollow fiber membranes consistent with the present disclosure.

FIGS. 3 A and B are graphs comparing elemental analysis of theoretical and experimental mixed-matrix hollow fiber consistent with the present disclosure.

FIG. 4 is a graph comparing permeability data in PDMS and 6FDA-DAM polyimide

FIG. 5 is a graph showing selectivity of PDMS-coated 6FDA-DAM hollow fiber vs. percentage of fiber skin defects.

FIG. 6 is a chart comparing C₃H₆/C₃H₈ selectivities of polyimide-based dense films and hollow fibers.

### DETAILED DESCRIPTION

Described herein are dual-layer mixed-matrix hollow fiber membranes suitable for a variety of separations, including olefin/paraffin separations. The materials described herein are mixed-matrix membranes including both polymers and inorganic components. The combination of polymers and inorganic materials in a mixed-matrix material overcomes limitations of either of the individual components. Previously known mixed-matrix membranes are predominantly based on zeolites that require sophisticated surface modifications to adhere with glassy polymer matrices. Zeolite-based mixed-matrix membranes have not previously been successfully scaled up into hollow fibers for separating olefin/paraffins. The mixed matrix materials disclosed herein include metal organic framework (MOF) particles dispersed in a polymer and formed into a hollow fiber. The MOF/polymer mixed-matrix hollow fibers are formed using a dry-jet/we-quench fiber spinning technique and have MOF nanoparticle loading of up to about 30 wt %. The MOF/polymer mixed-matrix hollow fibers show good C₃H₆/C₃H₈ selectivity.

Also described herein are pyrolyzed versions of the MOF/polymer mixed-matrix hollow fiber materials, which are MOF/carbon molecular sieve (CMS) hollow fiber materials. After pyrolysis of the MOF/polymer mixed-matrix hollow fiber membranes and aging of the resulting MOF/CMS hollow fiber membranes, the MOF/CMS membranes have increased C₃H₆ permeance and increased selectivity over the MOF/polymer mixed-matrix hollow fiber membranes.

Optionally the MOF particles are nanoparticles. As used herein, nanoparticles, or nano-scale particles, refers to particles having an average diameter in the range of from about 1 nanometer to about 100 nanometers. As used herein, micron-scale particles refers to having an average equivalent diameter in the range of from about 1 micrometer to about 1000 micrometers.

ZIFs are a subcategory of metal-organic frameworks (MOFs) with zeolite or zeolite-like topologies. We have studied ZIF-8 (Zn(MeIM)₂, MeIM=2-methylimidazole) with sodalite (SOD) topology. Adding ZIF-8 molecular sieve particles into the matrix of 6FDA-DAM polyimide to form ZIF-8/6FDA-DAM mixed-matrix dense film membrane significantly enhances membrane separation performance (C₃H₆ permeability and C₃H₆/C₃H₈ selectivity). However, the geometry of the symmetric dense film is not desirable for industrial applications due to low productivity (permeance) and low ratio of membrane surface area/membrane module volume. On the other hand, the geometry of an asymmetric hollow fiber combines advantages of high productivity and high ratio of membrane surface area/membrane volume, so it is a very attractive geometry for industrial gas separations.

We successfully scaled up a ZIF-8/6FDA-DAM mixed-matrix material from symmetric dense film membrane to asymmetric hollow fiber membrane by spinning dual-layer ZIF-8/6FDA-DAM mixed-matrix hollow fiber membranes from spinning dope compositions disclosed herein using spinning methods disclosed herein. The resulting mixed-matrix hollow fiber membranes showed significantly enhanced C₃H₆/C₃H₈ separation performance over single-layer pure polymer hollow fiber membranes and are therefore very attractive for practical applications.

Permeation of gas molecules through nonporous membranes follows the solution-diffusion mechanism. Gas molecules dissolve at the high concentration (upstream) side of the membrane and diffuse through the membrane along a concentration gradient to the low concentration (downstream) side of the membrane. Permeability is commonly used to characterize productivity of a membrane. The permeability of gas A is defined as the steady-state flux (N_{A}), normalized by trans-membrane partial pressure difference (Δρ_{A}) and thickness of effective membrane selective layer (l):

$${P}_{A} = \frac{{N}_{A} \cdot l}{Δ {p}_{A}} \qquad ( 1 )$$

Permeability is traditionally given in the unit of Barrer:

$$1 Barrer = 1 \times {10}^{- 10} \frac{{cm}^{3} ( STP ) \cdot cm}{{cm}^{2} \cdot s \cdot cm Hg}$$

For asymmetric membranes, the thickness of effective membrane selective layer usually cannot be reliably determined. Therefore membrane productivity is described by permeance, which is simply the trans-membrane partial pressure normalized flux:

$$( \frac{{P}_{A}}{I} ) = \frac{{N}_{A}}{Δ {p}_{A}} \qquad ( 2 )$$

“Gas permeation unit” or GPU is usually used as the unit of permeance, which is defined as:

$$1 G P U = {10}^{- 6} \frac{{cm}^{3} ( STP )}{{cm}^{2} \cdot s \cdot cm Hg}$$

Ideal selectivity and separation factors are usually used to characterize the efficiency of a membrane to separate a faster-permeating species A from a slower-permeating species B. For single gas permeation, the ideal selectivity of the membrane is defined as the ratio of single gas permeabilities or permeances:

$${α}_{A / B} = \frac{{P}_{A}}{{P}_{B}} = \frac{( {P}_{A} / l )}{( {P}_{B} / l )} \qquad ( 3 )$$

When a gas mixture permeates through a membrane, the separation factor is written as:

$${α}_{AB} = \frac{( {y}_{A} / {y}_{B} )}{( {x}_{A} / {x}_{B} )} \qquad ( 4 )$$

where y and x are mole fractions in the downstream and upstream side of the membrane.

Asymmetric hollow fiber membranes can be formed by the dry-jet/wet-quench fiber spinning technique. For spinning of single-layer pure polymer hollow fiber membrane, a polymer solution (dope) that contains polymer, solvents and non-solvents are co-extruded from a spinneret with a bore fluid into an air gap (“dry-jet”) and then immersed into a water quench bath (“wet-quench”). In the air gap, due to evaporation of volatile components in the dope, the dope composition is driven to the vitrified region and a dense and selective skin is formed. As the fiber is drawn through the water quench batch, water (non-solvent) diffuses into the polymer dope and induces phase separation. The polymer dope precipitates in the water quench bath and gains mechanical strength. In this way, an asymmetric hollow fiber membrane is formed with a thin dense skin layer on top of a porous substrate.

Dual-layer mixed-matrix hollow fibers can be spun with the same dry-jet/wet-quench technique, except that two dopes (sheath dope and core dope) are co-extruded from the spinneret with the neutral bore fluid. Usually the sheath dope contains molecular sieve particles. Formation of the dense mixed-matrix skin layer is caused by evaporation of volatile components from the sheath dope as it travels through the air gap.

Fiber skin integrity is one of the most important features of asymmetric hollow fiber membranes. Defects in the fiber skin will lead to non-selective Knudsen diffusion through membrane and therefore significantly undermine its separation efficiency. Typically, spinning of hollow fiber membranes with minimal skin defects can be achieved by careful selection of spinning dope composition and spinning parameters.

Spinning of mixed-matrix hollow fiber membranes without skin defects is much more challenging. In mixed matrix hollow fiber membranes, skin defects can be caused by agglomerations of molecular sieve particles with dimensions that are comparable to skin layer thickness. Also, the presence of molecular sieve particles in the spinning dope will impact the phase separation process and therefore the formation of integral fiber skin.

Ideally, the mixed-matrix hollow fiber membranes should show economically attractive selectivity and permeance that are enhanced over the neat polymer membrane. The membrane should be easily and inexpensively processed. Certain properties are desirable to make a mixed-matrix hollow fiber membrane conceptually feasible, that is, to demonstrate consistent selectivity with a dense film membrane of the same particle and polymer combination. The properties required for a conceptually feasible membrane are (1) forming a dual-layer hollow fiber with particles only in the sheath (outside) layer; (2) excellent particle-polymer adhesion; (3) generally well-dispersed particles with minimal agglomerations; (4) integral skin layer with minimal skin defects; and (5) uniform fiber wall thickness with porous substrate free of macrovoids.

Additionally, certain properties are desirable to make the MMHFM economically attractive.′ Those properties include (6) generally well-dispersed nanosized particles with minimal agglomerations; (7) sufficiently high particle loading to show economically attractive selectivity; (8) minimized skin thickness (<200-500 nm) to enable higher permeance and minimized sheath layer thickness (<1-5 micron) to minimize membrane material cost; (9) inexpensive polymer as fiber core layer with excellent inter-layer adhesion between sheath layer and core layer; and (10) hollow fine fibers (fiber outer diameter (OD)<150-300 micron) collected at high take-up rates (>50 m/min) to achieve higher membrane packing density.

The particle loading in prior known mixed-matrix hollow fibers using commercial polymers was typically low (less than about 20 wt %). Those materials achieved only moderately enhanced selectivity over the pure polymer hollow fiber for separation of permanent gases (e.g. CO₂/CH₄ and O₂/N₂). Due to limited advances in properties (1)-(5) above, the more advanced properties (6)-(10) have rarely been explored. We have explored these properties and the materials described herein are both actually achievable and economically attractive.

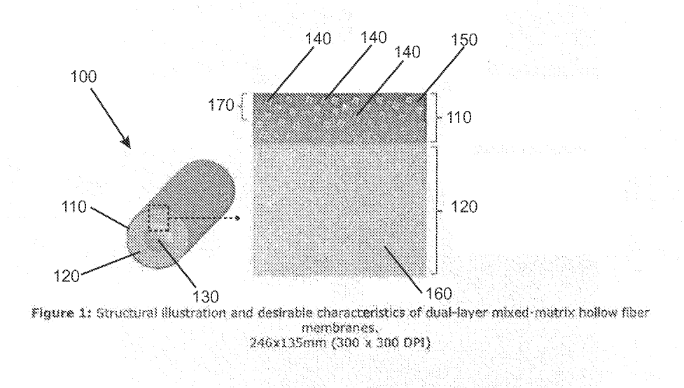

FIG. 1 is a schematic showing a mixed-matrix hollow fiber membrane 100 consistent with the present disclosure. The hollow fiber has a sheath layer 110, a core layer 120, and a hollow center 130. The sheath layer includes dispersed MOF particles 140. Optionally the particles 140 are nanoparticles. The particles 140 should be well dispersed with minimal agglomerates. The particles 140 in the sheath layer 110 are dispersed in a polymer 150. The core layer 120 includes a polymer 160 that may be the same as or different from the polymer 150 of the sheath layer 110, but is substantially free of any MOF particles 140. Substantially free of MOF particles means that no MOF particles are intended to be present in the core layer 120, but if a small amount of MOF particles end up in the core layer 120 as impurities, such a material still would be within the scope of this disclosure.

The sheath layer 110 has a small thickness relative to the thickness of the core layer 120. The sheath layer 110 includes at its outer surface a thin dense skin layer 170.

Accordingly, provided herein are materials including a hollow fiber including a sheath layer, wherein the sheath layer comprises a plurality of metal organic framework (MOF) particles dispersed in a first polymer; and a core layer adjacent to and radially inward from the sheath layer, wherein the core layer comprises a second polymer. Optionally, the first and second polymers are the same polymer, but optionally, the first and second polymers are different polymers. Optionally, the first polymer includes a polyimide (e.g., 6FDA-DAM, 6FDA/BPDA-DAM, 6FDA-DAM/DABA, 6FDA-6FpDA, 6FDA-durene, Matrimid®, or P84®), a polyamide-imide (e.g., Torlon®), a polyetherimide (e.g. Ultem®), or a cellulose acetate). Optionally, the second polymer is a polyimide (6FDA-DAM, 6FDA/BPDA-DAM, 6FDA-DAM/DABA, 6FDA-6FpDA, 6FDA-durene, Matrimid®, or P84®), a polyamide-imide (e.g., Torlon®), a polyetherimide (e.g. Ultem®), or a cellulose acetate.

Optionally, the MOF particles are zeolitic imidazolate framework (ZIF) particles (e.g., ZIF-7, ZIF-8, ZIF-9, ZIF 90, and hybrid ZIF's including a mixture of two or more imidazolate ligands of the above pure ZIF's). The MOF (or ZIF) particles optionally are nanoparticles. Optionally the MOF (or ZIF) particles are present in the sheath layer in an amount of at least 16% by weight (e.g., at least 20% by weight). Optionally, the core layer is substantially free of MOF (or ZIF) particles.

Optionally, the sheath layer has a thickness of less than about 5 micron (e.g., from about 1 to about 5 micron). Optionally, the fiber has an outer diameter equal to or less than about 300 micron (e.g., from about 150 to about 300 micron).

Particle Polymer Interface.

Particle-matrix interface refers to adsorption of polymer chains on particle surface with interfacial polymer chain packing density identical with the bulk polymer phase. Any deviations may lead to non-idealities and experimental transport properties inconsistent with theoretically predicted values. Inorganic molecular sieves such as zeolites and CMS are not highly compatible with glassy polymers and usually require sophisticated surface treatments to realize good adhesion and enhanced selectivity. The present disclosure successfully addresses this challenge of achieving ideal polymer-particle interface by forming mixed-matrix membranes with hydrophobic MOFs and ZIFs that are intrinsically compatible with glassy polymers.

Uniformly Disperse Nano-Sized Particles in Fiber Skin Layer.

The selective layer of an asymmetric mixed-matrix membrane cannot be thinner than the diameter of a single particle without creating undesirable membrane defects. Accordingly, nanosized particles are preferred to micro-sized particles for the purpose of minimizing membrane thickness and maximizing membrane permeance. However, nanosized particles, especially at high concentration, tend to agglomerate more seriously due to their much higher surface energy. The agglomerates in the fiber spinning dope, if sufficiently large, may plug narrow spinneret channels, thereby leading to non-uniform fibers. If present in the fiber skin layer, such agglomerates can also be detrimental to membrane selectivity by introducing skin defects, in the case that the dimension of agglomerates is larger than or comparable with the thickness of the fiber, skin layer.

High-Loading Mixed-Matrix Hollow Fiber Membrane Processing.

The mixed-matrix hollow fiber membrane disclosed herein are distinguishable from hollow fiber sorbents, in which the entire fiber wall is porous without a defect-free dense skin layer. For hollow fiber sorbents, breakthrough capacity increases with increasing particle content. For mixed-matrix membranes, selectivity increases with increasing particle loading in the skin layer, and is most attractive for high particle loadings. The processability of fiber spinning dope depends on the concentration of solids (polymer and particles). Overly high solid concentration makes the spinning dope difficult to mix homogeneously and extrude from a spinneret.

Since a skin layer is unnecessary for hollow fiber sorbents, polymer concentration in its spinning dope can be reduced to about 10 wt % as long as sufficient dope spinnability is retained. Therefore, it is not so challenging to form hollow fiber sorbents with particle loading as high as 70-80 wt %. However, the workable particle loading of mixed-matrix hollow fiber membrane are limited by the requirements on fiber skin integrity. Sufficiently high polymer concentration (usually at least 18-20 wt %, depending on the specific polymer and its Mw) is used in the spinning dope to form an integral skin with minimal defects and good selectivity. With such high polymer concentration, there is a limit in particle loading of the solidified mixed-matrix hollow fiber membrane, above which the spinning dope would become too difficult to process conveniently at large scale.

It is also difficult to form a thin and defect-free fiber skin layer under high particle loading. Fiber skin formation is a complicated process involving many variables and the effects of particles on skin formation are not yet well understood. As fiber skin becomes thinner, the probability of fiber skin defects increase dramatically due to over-sized particle agglomerates. While their number can be reduced, particle agglomerates remain a challenge that must be managed during dope extrusion in narrow spinneret channels, owing to high shear rates. Successful spinning of high-loading (>20 wt % particles) mixed-matrix hollow fiber gas separation membrane has not been reported previously.

Balancing Fiber Microscopic Properties with Macroscopic Properties.

Among the fiber properties described above, properties (2)-(7) are related to fiber skin formation and can be conveniently referred to as fiber microscopic properties. On the other hand, properties (1) and (8)-(10) are referred to as fiber macroscopic properties. Once a polymer and particle are selected, these properties will be determined by spinning dope compositions and spinning parameters. In fact, it is difficult to isolate one variable from others since there is a complex interplay between spinning dope rheology, fiber skin vitrification, and phase separation kinetics/thermodynamics.

Often changing one variable may lead to more desirable microscopic properties but will limit the degree of freedom to tune macroscopic properties, and vice versa. For example, longer air gap residence time and cooler quench batch will help to achieve more desirable sheath/core inter-layer adhesion. However, this will inevitably increase fiber skin thickness and limit the maximum fiber take-up speed and minimum fiber OD. For neat polymer hollow fiber membranes, this conflict may be conveniently resolved by optimizing spinning dope composition (such as adding lithium nitrate (LiNO₃) and increasing volatile component concentration) and spinning parameters (such as increasing spinneret temperature). However, for mixed-matrix hollow fiber membranes, especially at higher particle loading, fiber skin integrity is more sensitive to changes in these variables. Accordingly, the “window” allowed to tailor fiber skin thickness and control fiber skin integrity is narrower, and it is more challenging to obtain simultaneously desired fiber microscopic and macroscopic properties.

As a notable advancement over previous research that used micron-sized particles for mixed-matrix hollow fiber spinning, the materials described herein use nanosized particles. Optionally, an inexpensive commercial polymer may be used to form the fiber core layer with a high-performance polymer as the sheath layer polymer. Optionally, the polymers in the core layer and the sheath layer may be the same.

Formulation of fiber spinning dope is critical to formation of hollow fiber membranes with integral fiber skin and desired transport properties. The conventional “cloud point” technique developed for neat polymer hollow fiber membranes cannot be used to determine dope compositions for mixed-matrix hollow fiber membranes, since the added particles would make the dope opaque even in the one-phase region. A systematic empirical approach was employed to develop dope composition for ZIF-8/6FDA-DAM mixed-matrix hollow fiber membranes, based on the established dope composition of neat 6FDA-DAM hollow fiber membrane we previously studied. Optionally, LiNO₃ may be added in the spinning dope of neat 6FDA-DAM hollow fibers to accelerate phase separation and to improve fiber spinnability; however, it may be difficult to control fiber skin integrity in the presence of LiNO₃. Thus, optionally the sheath spinning dope optionally may not include LiNO₃.

As one example for a mixed-matrix fiber with 17 wt % ZIF-8 loading, the polymer concentration in the sheath spinning dope was fixed around 25 wt % (in this case 26 wt %). Concentration of ZIF-8 in the dope was then determined based on the desired particle loading in the solidified fiber sheath layer. Ethanol concentration was reduced so that the total non-solvent (ethanol and ZIF-8) concentration was comparable between these two dopes (15.5 wt % for neat polymer fiber spinning dope vs. 14.2 wt % for mixed-matrix fiber spinning dope). To assist fiber skin formation, the THF concentration was increased from 10 wt % to 16 wt %.

The sheath dope composition of dual-layer ZIF-8(30 wt %)/6FDA-DAM mixed-matrix hollow fiber is the highest particle loading that has been reported in the literature for mixed-matrix hollow fibers. If the polymer concentration is fixed at 26 wt %, ZIF-8 concentration must be above 11 wt % to reach the desired loading in the solidified sheath layer. This was found to be very challenging in practice since high concentration of polymer, and high concentration of particles would make the dope extremely viscous and difficult to process. To address the processability issue, polymer concentration was reduced to 20 wt %, reducing the required ZIF-8 concentration to 8.5 wt %. The resulting sheath spinning dope was still very viscous, but processable. With increasing concentration of ZIF-8, ethanol concentration was decreased to 7.5 wt %. Reducing polymer concentration tends to produce more defective fiber skin, thus the THF concentration was dramatically increased from 16 wt % to 44 wt % to aid fiber skin formation.

Table 1 shows exemplary spinning dope compositions (wt %) of dual-layer ZIF-8/6FDA-DAM mixed matrix hollow fiber membranes. The dope composition of an exemplary neat 6FDA-DAM hollow fiber membrane is shown for reference.

TABLE 1

| | | | | Core |
|---|---|---|---|---|
| | Sheath Spin Dope | | | Spin |
| Component | Neat Polyimide | 17 wt % ZIF-8 | 30 wt % ZIF-8 | Dope |
| 6FDA-DAM | 25 | 26 | 20 | 20.5 |
| NMP | 49.5 | 43.8 | 20 | 48 |
| THF | 10 | 16 | 44 | 10 |
| Ethanol | 12 | 9 | 7.5 | 15 |
| LiNO₃ | 3.5 | 0 | 0 | 6.5 |
| ZIF-8 | 0 | 5.2 | 8.5 | 0 |

As shown in Table 2, a wide range of spinning parameters was used for dual-layer ZIF-8/6FDA-DAM mixed matrix hollow fibers by varying dope flow rates, air gap height, and quench bath temperature. Spinning parameters of the spinning state showing the highest fiber selectivity are shown in parenthesis.

TABLE 2

| Spinning parameter | 17 wt % ZIF-8 fiber | 30 wt % ZIF-8 fiber |
|---|---|---|
| Sheath dope flow rate (cc/hr) | 15-30 (15) | 15-30 (15) |
| Core dope flow rate (cc/hr) | 150-300 (150) | 150-180 (150) |
| Bore fluid flow rate (cc/hr) | 55-100 (55) | 55-60 (55) |
| Quench bath temperature (° C.) | 25-50 (25) | 12-25 (12) |
| Spinneret temperature (° C.) | 50-60 (60) | 50-60 (60) |
| Air gap height (cm) | 7-30 (10) | 2-30 (2) |
| Take-up rate (m/min) | 5-20 (10) | 5-20 (20) |

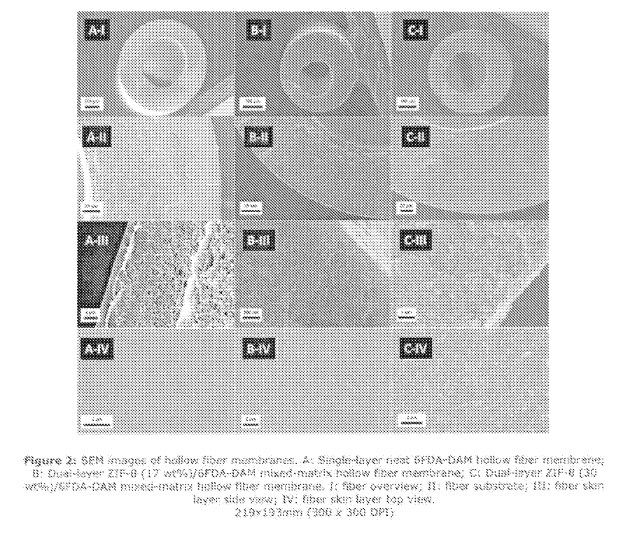

Since particle agglomerations may be more serious at higher particle concentration, a cooler quench bath (12-25° C.) was used for 30 wt % ZIF-8 loading mixed-matrix fiber. A lower quench batch temperature may produce thicker and less defective skin. Spinning parameters of the spinning state showing the highest fiber selectivity are shown in parentheses. FIG. 2 shows SEM images (fiber overview, fiber substrate, fiber skin side view, and fiber skin top view) of dual-layer ZIF-8/6FDA-DAM mixed-matrix hollow fibers. FIG. 2 column A shows a single-layer neat 6FDA-DAM hollow fiber membrane, column B shows a dual-layer ZIF-8 (17 wt %)/6FDA-DAM mixed-matrix hollow fiber membrane, and column C shows a dual-layer ZIF-8 (30 wt %)/6FDA-DAM mixed-matrix hollow fiber membrane. Row I shows overviews of the fibers with the scale bars at 100 micrometers. Row II shows the fiber substrate with the scale bars at 20 micrometers. Row III shows the fiber skin layer side view with the scale bars at 1 micrometer, 500 nanometers, and 1 micrometer for A, B, and C, respectively. Row IV shows a fiber skin layer top view with the scale bars at 1 micrometer, 2 micrometers, and 2 micrometers for A, B, and C, respectively. Column A is provided for reference. The mixed-matrix fibers had generally attractive macroscopic properties with an OD of about 400 micrometers and sheath layer thickness of 7-12 micrometers. Striking differences were observed for fiber skin top views (FIG. 2, A-IV, B-IV, and C-IV). While the skin surface of neat 6FDA-DAM fiber appeared to be completely smooth without any observable features, the surface of the mixed-matrix fiber skin displayed many small “nodules” with dimensions close to the size of individual ZIF-8 nanoparticles (diameter of about 100 nm). In addition, these “nodules” seem to become more densely packed as particle loading increased from 17 wt % to 30 wt %.

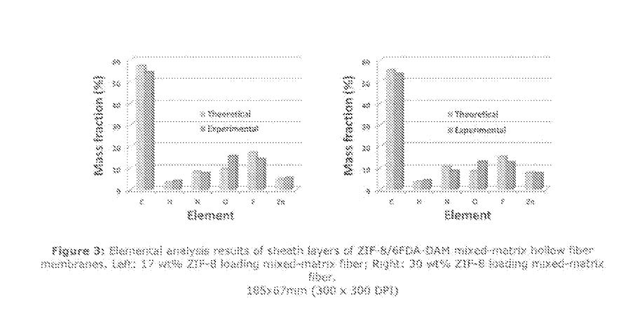

Many circular sockets with diameter of about 100 nm can be seen in skin side views of mixed-matrix fiber (FIG. 2, B-III & C-III). Such morphology was not observed for neat 6FDA-DAM fiber without ZIF-8 nanoparticles (FIG. 2, A-III). Formation of these sockets may be due to ZIF-8 nanoparticles “popping out” from the fiber upon aggressive sample fracturing in liquid nitrogen and therefore is not an indication of fiber skin defects. It should be noted that due to these sockets, the transition from fiber dense skin and the underneath porous region was unclear. As a result, it was hard to unambiguously estimate skin layer thickness of mixed-matrix hollow fiber membranes simply based on SEM imaging. The presence of ZIF-8 particles in the fiber sheath layer was further confirmed by elemental analysis of hollow fiber sheath layers. FIG. 3 shows graphs comparing theoretical and experimental elemental analysis results of sheath layers of ZIF-8/6FDA-DAM mixed-matrix hollow fiber membranes. FIG. 3A shows the comparison for a fiber having 17 wt % ZIF-8 loading, and FIG. 3B shows the comparison for a fiber having 30 wt % ZIF-8 loading. As shown in FIG. 3, experimental Zn weight fractions agreed very well with the theoretical values.

Also provided herein is a MOF/carbon molecular sieve (CMS) mixed-matrix hollow fiber membrane formed by pyrolyzing a MOF/polymer mixed-matrix hollow fiber membrane. Pyrolysis causes the polymeric materials to form hexagonal carbon sheets with a plurality of pores. During pyrolysis, the polymers of the sheath and core layers of the MOF/polymer mixed-matrix hollow fiber become greater than about 90 to 95% disordered hexagonal carbon sheets with a plurality of pores. Different polymers will produce carbon sheets having different pore size distributions. Accordingly, a MOF/CMS mixed-matrix hollow fiber membrane formed from a pyrolyzed MOF/polymer mixed-matrix hollow fiber membrane includes a sheath layer including a plurality of MOF particles dispersed in a first CMS including a first plurality of pores; and a core layer adjacent to and radially inward from the sheath layer, wherein the core layer includes a second CMS including a second plurality of pores. If the MOF/polymer mixed-matrix hollow fiber included the same polymer in its sheath and core layers, the CMS in the sheath and core layer would be substantially the same in chemical composition and would have the same pore size distribution. Optionally the first and second CMSs are substantially the same in chemical composition. Optionally, the first and second CMSs include disordered hexagonal carbon sheets. Optionally, the first plurality of pores and the second plurality of pores are of substantially the same size. Optionally, the first plurality of pores has an average pore size greater than the average pore size of the second plurality of pores. Optionally, the first plurality of pores has an average pore size less than the average pore size of the second plurality of pores.

Optionally, the MOF particles include zeolitic imidazolate framework (ZIF) particles (e.g., ZIF-7, ZIF-8, ZIF-9, ZIF 90, and hybrid ZIF's including a mixture of two or more imidazolate ligands of the above pure ZIF's). The MOF (or ZIF) particles optionally are nanoparticles. Optionally the MOF (or ZIF) particles are present in the sheath layer in an amount of at least 16% by weight (e.g., at least 20% by weight). Optionally, the core layer is substantially free of MOF (or ZIF) particles.

Optionally, the sheath layer has a thickness of less than about 5 micron (e.g., from about 1 to about 5 micron). Optionally, the fiber has an outer diameter equal to or less than about 300 micron (e.g., from about 150 to about 300 micron).

We have repeatedly explained that agglomerated particles in the sheath dope are undesirable. We disclose herein a valuable approach to form ZIF-based mixed-matrix hollow fiber membranes with minimal particle agglomerations by avoidance of drying ZIF particles before mixing with other components in the sheath spinning dope. After being dried, either under atmosphere or vacuum with or without heat, nano-sized ZIF/MOF particles tend to exist as agglomerates and are very difficult to redisperse in solvents even with strong sonication. It is important that the ZIF-8 particles should not be dried, including at atmosphere or under vacuum, before forming the sheath spinning dope. Drying the ZIF-8 particles results in most particles existing as particle agglomerations in the sheath spinning dope.

Accordingly, provided herein are methods of forming the mixed-matrix hollow fibers. The methods include a method of forming a hollow fiber including combining a first polymer, a plurality of MOF particles, and one or more solvents to form a sheath dope; combining a second polymer and one or more solvents to form a core dope; and co-extruding the sheath dope, the core dope, and a bore fluid through a spinneret to form a hollow fiber. Optionally the MOF particles are not dried prior to the step of forming the sheath dope. Optionally the step of combining the first polymer, the plurality of MOF particles, and one or more solvents to form a sheath dope includes dissolving a first portion of the first polymer in a first portion of a first solvent to form dope A; combining MOF particles with a second portion of the first solvent to form a MOF/solvent slurry; adding dope A to the MOF/solvent slurry to form dope B; adding a second portion of the first polymer to dope B to form a paste; adding a second solvent to the paste to form dope C; adding a third portion of the first polymer to dope C to form the sheath dope. Optionally, the MOF particles are not dried prior to the step of forming the MOF/solvent slurry.

Optionally, the MOF particles include ZIF particles (e.g., ZIF-7, ZIF-8, ZIF-9, ZIF 90, and hybrid ZIF's including a mixture of two or more imidazolate ligands of the above pure ZIF's). The MOF (or ZIF) particles optionally are nanoparticles. Optionally the MOF (or ZIF) particles are present in the sheath dope in an amount of about 5 to about 9% by weight. Optionally, the core dope is substantially free of MOF (or ZIF) particles.

Optionally, the first and second polymers are the same. Optionally, the first and second polymers are different. Optionally, the first polymer includes a polyimide (e.g., 6FDA-DAM, 6FDA/BPDA-DAM, 6FDA-DAM/DABA, 6FDA-6FpDA, 6FDA-durene, Matrimid®, or P84®), a polyamide-imide (e.g., Torlon®), a polyetherimide (e.g. Ultem®), or a cellulose acetate)). Optionally, the concentration of the first polymer in the sheath dope is about 20 to about 26% by weight. Optionally the second polymer includes a polyimide (e.g., 6FDA-DAM, 6FDA/BPDA-DAM, 6FDA-DAM/DABA, 6FDA-6FpDA, 6FDA-durene, Matrimid®, or P84®), a polyamide-imide (e.g., Torlon®), a polyetherimide (e.g. Ultem®), or a cellulose acetate). Optionally, the core dope further comprises lithium nitrate and the sheath dope does not comprise lithium nitrate.

Optionally, the methods further include a step of coating the hollow fiber with a third polymer. Optionally, the third polymer includes a polyaramid, a polydimethylsiloxane, or a polyaramid/polydimethylsiloxane mixture. Optionally the methods further include a step of quenching the hollow fiber in a water bath at a temperature of from 12 to 50 degrees C. (e.g., from 12 to 25 degrees C.).

Also provided herein are methods of separating a first component from a second component of a multicomponent mixture using membranes comprising any material described herein. Optionally, the first component comprises propylene and the second component comprises propane. Optionally, the first component comprises carbon dioxide and the second component comprises methane. Optionally, the first component comprises oxygen and the second component comprises nitrogen. Optionally, the first component comprises ethylene and the second component comprises ethane. Optionally, the first component comprises n-butane and the second component comprises iso-butane.

Also provided herein are methods of forming the MOF/CMS mixed-matrix hollow fibers. A MOF/polymer mixed-matrix hollow fiber is heated to a final pyrolysis temperature (e.g., about 450° C. to about 650° C., or about 500° C. to about 600° C.). The fiber is then heated at the final pyrolysis temperature (e.g., about 450° C. to about 650° C., or about 500° C. to about 600° C.) for one minute to twelve hours (e.g., for about 2 hours to about 4 hours) and then cooled to about room temperature (about 19° C. to about 24° C.). The entire pyrolysis process is carried out under inert gas (e.g., argon or nitrogen). The flow rate of the inert gas is within a range of one to 500 cubic centimeters per minute. Optionally, the fiber starts the process at about room temperature (e.g., at about 19° C. to about 24° C.). Optionally, the fiber starts the process at a temperature higher than room temperature. Optionally, the step of heating to the final pyrolysis temperature may be a one-step process. Optionally, the step of heating to the final pyrolysis temperature may be a multi-step process, wherein each step includes heating at a different rate (e.g., at least two steps, wherein the heating rate is faster during the first step than during the second step, or at least three steps wherein the heating rate is faster during the first step than during the second step and faster during the second step than during the third step).

As an alternative to conventional CMS membranes pyrolyzed from pure polymeric precursors, the method disclosed herein offers an opportunity to control the microstructure and transport properties for CMS membranes. While specific examples herein refer to CMS membranes formed from ZIF-8/6FDA-DAM mixed-matrix hollow fiber membranes for C₃H₆/C₃H₈ separation, the disclosed approach can be extended to separation of other gas pairs, using mixed-matrix membranes formed by other type of polymers and molecular sieve particles.

The materials and methods described herein can potentially be extended to separation of other gas mixtures including natural gas purification, air separation, post-combustion CO₂ capture, and separation of hydrocarbon isomers.

### EXAMPLES

### Experimental Methods

Permeation measurements of hollow fiber membranes were performed at 35° C. using the constant volume method. Permeation of C₃H₆/C₃H₈ was done with mixed-gas feed (50/50 vol. %) while O₂/N₂ was done with single-gas feeds. The upstream pressure was about 29.4 psia (about 0.2 MPa) for O₂/N₂ permeation; and was about 20 psia (about 0.14 MPa) for C₃H₆/C₃H₈ permeation. For mixed-gas measurements, permeate compositions were analyzed with a Varian-450 gas chromatograph (GC). The stage cut was kept less than 1% to avoid concentration polarization. Scanning electron microscopy (SEM) imaging was done on a LEO 1530 field emission scanning electron microscope (LEO Electron Microscopy, Cambridge, UK). Elemental analysis of the mixed-matrix hollow fiber samples was done by ALS Environmental (Burnaby, Canada). Carbon, nitrogen, hydrogen, and oxygen were analyzed by combustion/IR. Fluorine was analyzed by combustion/IC. Zinc analysis was done by total dissolution.

### Example 1. Preparation of Spin Dope for Dual-Layer Mixed-Matrix Hollow Fiber Membranes

### Preparation of ZIF-8 Nanoparticles

29.4 g Zn(NO₃)₂.6H₂O and 32.4 g 2-methylimidazole were each dissolved in 2 L methanol. The molar ratio of Zn/MeIM/MeOH was 1:4:1000. The latter solution was poured into the former solution under stirring with a magnetic bar. Stirring was stopped after mixing. After 24 hours, the white solids were separated from the dispersion by centrifugation, followed by extensive washing with methanol.

### Preparation of 6FDA-DAM

6FDA-DAM polyimide (Mw=192 kDa) was synthesized using a step growth polymerization. The monomers 6FDA (2,2-bis (3,4-carboxyphenyl) hexafluoropropane dianhydride and DAM (diaminomesitylene) were purchased from Sigma-Aldrich and purified by sublimation before polymerization.

### Preparation of ZIF-8/6FDA-DAM Spin Dope

Two spinning dopes (core spinning dope and sheath spinning dope) were used to spin dual-layer ZIF-8/6FDA-DAM mixed-matrix hollow fiber membranes. The core spinning dope contained polymer, solvents, non-solvents and was free of ZIF-8 particles. N-methyl-2-pyrrolidone (NMP) and tetrahydrofuran (THF) were used as solvents. Ethanol was used as the non-solvent. The core spinning dope was prepared following the conventional dope preparation technique. Lithium nitrate (LiNO₃) was added in the core spinning dope to improve dope spinnability and accelerate phase separation.

The sheath spinning dope contained ZIF-8 nanoparticles, 6FDA-DAM polyimide, solvents (NMP and THF), and non-solvent (ethanol). The mixed-matrix sheath spinning dope was prepared with the following procedure. 6FDA-DAM polyimide was dried under vacuum at 100° C. for at least 12 hours to remove condensables. 15 wt % of the total dried polyimide was dissolved in 30 wt % of the total solvents to form a dilute “priming” dope. After being washed with methanol, ZIF-8 particles (without being dried) were washed with NMP overnight to extract the residual methanol from the particles. After the NMP/methanol mixture is separated from the ZIF-8 particles by centrifuge, non-solvent (ethanol) and 70 wt % of the total solvents were added to the centrifuge vials. After being shaken overnight, the slurry was transferred from the centrifuge vials to a sealed 400 mL glass jar and sonicated for at least 1 hour using a sonication bath (Elmasonic P30H). Sonication horn was avoided due to possible Ostwald ripening effects that may undesirably change particle dimension and porosity. After ZIF-8 nanoparticles were re-dispersed, the priming dope was added under constant stirring. After the dope appeared to be homogeneous, the remaining 85 wt % of the total dried polyimide was added under constant stirring. Finally, the jar was sealed and placed on a rolling mixer for at least two weeks to ensure that a viscous and homogeneous white paste was formed.

### Example 2. Preparation of Spin Dope for Dual-Layer Mixed-Matrix Hollow Fiber Membranes

### Preparation of ZIF-8 Nanoparticles

14.7 g Zn(NO₃)2.6H₂O and 16.2 g 2-methylimidazole were each dissolved in 1 L methanol. The molar ratio of Zn/MelM/MeOH was 1:4:1000. The latter solution was poured into the former solution under stirring with a magnetic bar. Stirring was stopped upon mixing. After 24 hours, the milky colloidal dispersion was transferred to four centrifuge vials. White solids were separated from the milky colloidal dispersion by centrifugation, followed by extensive washing with methanol.

### Preparation of 6FDA-DAM

6FDA-DAM polyimide was synthesized using a step growth polymerization method as described in U.S. Pat. No. 4,933,132. The monomers 6FDA (2,2-bis (3,4-carboxyphenyl) hexafluoropropane dianhydride) and DAM (diaminomesitylene) were purchased from SigmaAldrich and purified by sublimation before polymerization. The Mw of the synthesized 6FDA-DAM was 192,000.

### Preparation of ZIF-8/6FDA-DAM Spin Dope

6FDA-DAM polyimide was dried under vacuum at 100° C. for at least 12 hours to remove moisture. 15 wt % of the total dried polyimide was dissolved in 60 wt % of the total N-methyl-pyrrolidone (NMP) to form dope A. Without being dried, ZIF-8 particles prepared as described above were washed with NMP overnight to extract the residual methanol from the particles. After the NMP/methanol mixture was separated from the ZIF-8 particles by centrifuge, 40 wt % of the total NMP was added to the centrifuge vials. After being shaken overnight, the ZIF-8/NMP slurry was transferred from the centrifuge vials to a 400 mL glass jar and sonicated for at least 2 hours to re-disperse the ZIF-8 particles before dope A was added under constant stirring to form a mixture of ZIF-8-NMP-polyimide to form dope B. 50 wt % of the total dried polyimide was added to the ZIF-8/NMP/polyimide mixture under constant stirring. After a homogeneous paste was formed, tetrahydrofuran (THF) and ethanol was added to the paste under constant stirring to form dope C. Afterwards, the balancing polymer (35 wt % of the total dried polymer) was added to the paste quickly to reduce evaporation of volatile components from the dope (THF and ethanol). Finally, the 400 ml glass jar containing ZIF-8, 6FDA-DAM polyimide, NMP, THF, and ethanol was sealed and placed on a rolling mixture for at least two weeks until a white, extremely viscous, and homogeneous paste was formed.

### Example 3. Spinning Dual-Layer Mixed-Matrix Hollow Fiber Membranes

The dual-layer ZIF-8/6FDA-DAM mixed-matrix hollow fiber membranes were spun using the dry-jet/wet-quench technique by co-extrusion of the sheath dope, core dope, and a bore fluid through a composite spinneret. To be compared with our previous work on ZIF-8/6FDA-DAM mixed-matrix dense film membranes, two batches of mixed-matrix hollow fibers were spun at ZIF-8 loading of 17 wt % and 30 wt % (in solidified fiber sheath layers), which were close to particle loading of dense film DAMZ_1 (16.4 wt % ZIF-8) and DAMZ_2 (28.7 wt % ZIF-8), respectively. Optimized dope compositions are shown in Table 1. The loading of ZIF-8 particles in the hollow fiber sheath layer was 16.7 wt %.

The sheath dope, core dope, and bore fluid (90 wt % NMP/10 wt % H₂O) were delivered to the spinneret with controlled flow rates by Isco syringe pumps. The spinning was carried out at desired temperature by heating the entire system including the dope delivery pump, tubing, dope filter and spinneret using multiple heating tapes controlled by temperature controllers. The dopes and bore fluid were co-extruded through an adjustable air gap into the water quench bath (height=1 m), passed over a Teflon guide in the quench bath and collected on a polyethylene rotating take-up drum (diameter=0.32 m). The take-up drum was partially immersed in a separate water bath at room temperature. The fiber take-up rate used in this research ranged from 5 to 50 m/min. Once cut off from the take-up drum, the dual-layer mixed-matrix fibers were soaked sequentially in at least four separate water baths for 3 days to remove residual organic solvents, and then solvent-exchanged with sequential 1 hr baths of methanol and hexane. After air-drying in a fume hood for 1 hr, the fibers were dried in a vacuum oven at 120° C. for −3 hrs to remove residual solvents in the fiber as well as to activate ZIF-8. The obtained fibers are referred to as as-spun fibers.

### Example 4. Hollow Fiber Post-Treatments

The surface of as-spun fibers was coated with polydimethylsiloxane (PDMS) and/or polyaramid to seal fiber skin defects, if any existed. To coat the fiber surface with PDMS, the as-spun fibers were contacted with a solution of 2 wt % PDMS (Sylgard® 184, Dow Corning) in isooctane. After 30 mins, the solution was drained and the residual iso-octane was removed from the fiber by degassing the fiber at 80° C. overnight in a vacuum oven. The obtained fibers are referred to as PDMS-coated fibers.

To coat the fiber surface with both PDMS and polyaramid, the as-spun fibers were contacted with a solution of 0.2 wt % diethyltoluene diamine (DETDA) in iso-octane for 30 mins and the solution was drained. The fibers were then further contacted with a second solution of 0.2 wt % trimesoyl chloride (TMC) and 2 wt % PDMS in iso-octane for 30 mins and the solution was drained. As the DETDA-impregnated fiber was brought contact with the TMC/PDMS solution, polycondensation occurred between the diamine (DETDA) and the crosslinker (TMC). As a result, crosslinked polyaramid was formed within the network of PDMS on fiber surface. The residual iso-octane was removed from the fiber by degassing the fiber at 80° C. overnight in a vacuum oven. The obtained fibers are referred to as PDMS/polyaramid-coated fibers.

### Example 5. Separations Using Dual-Layer ZIF-8/6FDA-DAM Mixed-Matrix Hollow Fiber Membranes

By varying the spinning parameters listed in Table 2, 10-12 different states were each obtained for 17 wt % and 30 wt % loading mixed-matrix fibers. The quality of as-spun fibers was first examined by O₂/N₂ single-gases permeation. Those states showing highest O₂/N₂ selectivities were further evaluated for C₃H₆/C₃H₈ separation with results shown in Table 3. Permeation data of single-layer neat 6FDA-DAM hollow fiber membrane are shown as well for reference.

TABLE 3

| | Permeance (GPU) | | Selectivity | |
|---|---|---|---|---|
| Fiber | O₂ | C₃H₆ | O₂/N₂ | C₃H₆/C₃H₈ |

Single-layer neat 6FDA-DAM hollow fiber membrane

| | | | | |
|---|---|---|---|---|
| As-spun fiber | 87.5 | 9.3 | 42 | 8.0 |
| PDMS-coated fiber | 78.0 | 7.3 | 4.2 | 8.5 |
| PDMS/polyaramid-coated fiber | 6.3 | 0.38 | 6.3 | 16.3 |

Dual-layer ZIF-8 (17 wt %)/6FDA-DAM mixed matrix hollow fiber membrane

| | | | | |
|---|---|---|---|---|
| As-spun fiber | 69.3 | 2.4 | 4.5 | 16.5 |
| PDMS-coated fiber | 66.5 | 2.2 | 4.5 | 17.7 |
| PDMS/polyaramid-coated fiber | 25.3 | 0.68 | 7.7 | 21.1 |

Dual-layer ZIF-8 (30 wt %)/6FDA-DAM mixed matrix hollow fiber membrane

| | | | | |
|---|---|---|---|---|
| As-spun fiber | 73.9 | 10.1 | 4.0 | 6.6 |
| PDMS-coated fiber | 59.5 | 6.0 | 4.2 | 16.4 |
| PDMS/polyaramid-coated fiber | 7.3 | 0.27 | 7.0 | 27.5 |

With added LiNO₃ in the core spinning dope, spinnability of dual-layer mixed-matrix hollow fibers was excellent. With 50° C. quench batch, dual-layer mixed-matrix fibers can be collected continuously at drawing speed as high as 50 m/min, which resulted in fine fibers with OD as small as ˜260 μm. However, initial examination with O₂/N₂ single-gases permeation suggested that fibers spun with 50° C. quench batch were defective with much lower selectivities. On the contrary, those states spun using cooler quench batch and lower drawing speed (10 m/min) generally had better selectivities. This was probably due to the thicker fiber skin formed with longer air gap residence time and slower phase separation in the cooler quench bath.

Spinning parameters of the state demonstrating highest O₂/N₂ selectivity are shown in parentheses of Table 2. For 17 wt % ZIF-8 loading mixed-matrix fiber, highest O₂/N₂ selectivity was achieved with air gap of 10 cm, drawing speed of 10 m/min and 25° C. quench bath. An O₂/N₂ selectivity of 4.5 was obtained for the as-spun fiber, which was slightly higher than the value (4.0) of mixed-matrix dense film with similar loading (DAMZ_1). The fiber skin thickness (˜2.7 μm) was estimated using O₂ permeability of DAMZ_1 (186 Barrer)¹⁹ and permeance of the as-spun mixed-matrix fiber (69.3 GPU). C₃H₆/C₃H₈ mixed-gas permeation showed that the as-spun fiber had good C₃H₆/C₃H₈ separation performance with C₃H₆ permeance of 2.4 GPU and C₃H₆/C₃H₈ selectivity of 16.5. It was surprising, yet obviously desirable to see, that the C₃H₆/C₃H₈ selectivity of the mixed-matrix fiber exceeded the value (13.7) of mixed-matrix dense film at similar loading (DAMZ_1). We hypothesize that this was due to better particle dispersion in hollow fibers using lab-synthesized ZIF-8 particles, which were less susceptible to agglomerations than a commercially available ZIF-8 sample used in our previous dense film work. Polymer chain orientations may also contributed to the increased selectivity, which resulted from extensional forces applied on the nascent fiber. In any case, this suggested successful formation of high-quality mixed-matrix fiber with minimal skin defects. Coating fiber surface with PDMS slightly enhanced C₃H₆/C₃H₈ selectivity to 17.7 with a minor drop of C₃H₆ permeance to 2.2 GPU. This indicates that tiny defects still existed, although apparently their impacts on C₃H₆/C₃H₈ selectivity were minimal. To our best knowledge, this was among the few studies that as-spun mixed-matrix hollow fiber membranes showed consistent selectivity with the mixed-matrix dense film. It was also the first time that mixed-matrix hollow fiber membrane showed enhanced selectivity for separation of condensable olefin/paraffin mixtures.

For 30 wt % ZIF-8 loading mixed-matrix fiber, highest O₂/N₂ selectivity (4.0) was achieved at quench bath temperature of 12° C. Those states spun under 25° C. quench bath temperature generally showed lower selectivities. The optimal state was further taken for C₃H₆/C₃H₈ mixed-gas permeation. Surprisingly, the C₃H₆/C₃H₈ selectivity of this state was only 6.6, which was significantly lower than the value (18.1) of mixed-matrix dense film membrane with similar loading (DAMZ_2). After coating the fiber surface with PDMS, O₂/N₂ selectivity slightly increased to 4.2 with O₂ permeance dropped by 20%. In the meantime, C₃H₆ permeance was reduced by 40% with C₃H₆/C₃H₈ selectivity increased to 16.4, which was still lower than the dense film selectivity. That is to say, PDMS coating wasn't effective to fully recover C₃H₆/C₃H₈ selectivity of 30 wt % ZIF-8 loading mixed-matrix fiber. Also, since the fiber was partially defective at 30 wt % loading, reliable estimation of fiber skin layer thickness was not possible.

### Example 6. Morphology of ZIF-8/6FDA-DAM Mixed-Matrix Hollow Fiber Membranes

SEM images of the defect-free dual-layer ZIF-8/6FDA-DAM mixed-matrix hollow fiber membrane that gave enhanced C₃H₆/C₃H₈ separation factor (Table 3) are shown in FIG. 2.

FIG. 2AI-IV shows a single-layer neat 6FDA-DAM hollow fiber membrane. FIG. 2BI-IV show a dual-layer ZIF-8 (17 wt %/6FDA-DAM mixed-matrix hollow fiber membrane. FIG. 2CI-IV show a dual-layer ZIF-8 (30 wt %)/6FDA-DAM mixed-matrix hollow fiber membrane. Row I shows overviews of the fiber cross-sections. The fiber in FIG. 2BI is free of macrovoids; however, is slightly non-concentric due to misaligned spinneret. This problem can be easily solved by aligning the spinneret. FIG. 2BII shows undesirable delamination between the fiber sheath and core layer. This problem can potentially be solved by decreasing the sheath dope flow rate and optimizing design of the spinneret. ZIF-8 particles can be seen in the cross-section of fiber skin layer in FIG. 2BIII. Some spherical holes with diameter of about 100 nm can be seen in FIG. 2BIII. This may be due to leaching-out of ZIF-8 particles from the fiber upon fracturing the fiber sample in liquid nitrogen and therefore is not an indication of fiber skin defects.

### Example 7. Effects of Coating Materials on Selectivity of Partially Defective Fibers

The effectiveness of a coating material to seal fiber skin defects depends on the relative permeability of the slower permeating component in the coating material and the membrane material comprising the fiber skin. In the case that the coating material is several orders of magnitude more permeable than the membrane, it may not be effective to slow down unselective Knudsen diffusion in fiber skin defects.

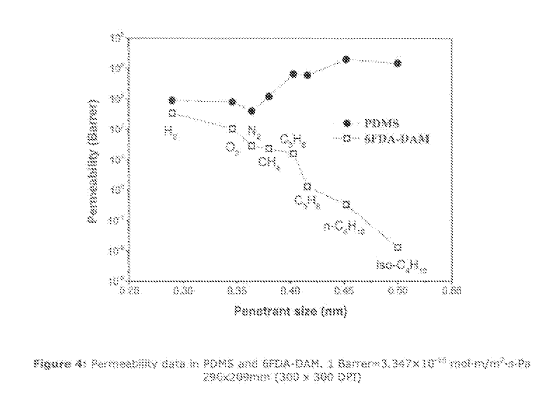

Permeability data in PDMS and 6FDA-DAM polyimide are plotted in FIG. 4 with penetrant molecular size. Permeation in rubbery PDMS is controlled by solubility, and permeability increases as the penetrant becomes more condensable. Permeation in glassy 6FDA-DAM is controlled by diffusion, and permeability decreases with increasing penetrant molecular size. Consequently, the permeability ratio between PDMS and 6FDA-DAM increases dramatically as the penetrant molecule becomes larger and more condensable. For example, the ratio of H₂ permeability is only about 3, while the ratio of n-C₄H₁₀ is over 6×10⁴.

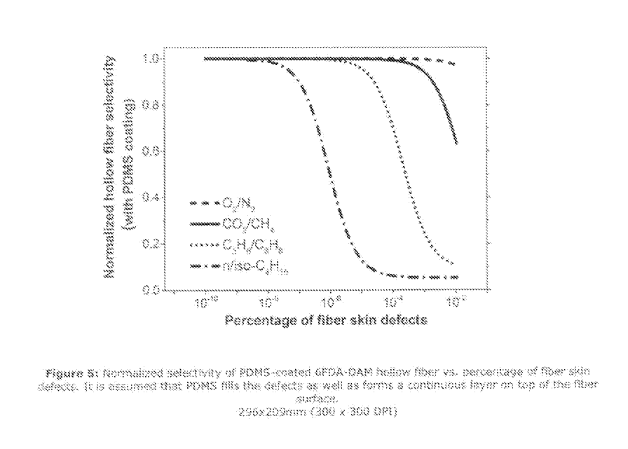

FIG. 5 further shows the effectiveness of PDMS to seal fiber skin defects for separation of O₂/N₂, CO₂/CH₄, C₃H₆/C₃H₈, and n-C₄H₁₀/iso-C₄H₁₀. The X axis is the fractional area (percentage) of fiber skin defects. The Y axis is the normalized selectivity of the coated fiber relative to the intrinsic selectivity of the fiber skin material. Calculations were done with the resistance model suggested by Henis and Tripodi. As a coating material to seal fiber skin defects, PDMS is not as effective for separation of highly condensable hydrocarbons as for separation of permanent gases. For example, assuming 0.1% fiber skin defects, selectivities of O₂/N₂, CO₂/C₄ were within 95% of the intrinsic selectivity after PDMS coating. Whereas C₃H₆/C₃H₈ and n-C₄H₁₀/iso-C₄H₁₀ selectivities of the PDMS-coated fiber were only less than 30% and 10% of the intrinsic selectivity, respectively. That is to say, it is much more challenging to obtain high-quality hollow fiber membranes that demonstrate desirable hydrocarbon selectivity that is consistent with dense film membrane. For PDMS-coated 6FDA-DAM hollow fibers, percentage of fiber skin defects has to be below 2×10⁻⁵ to show defect-free (90%) C₃H₆/C₃H₈ selectivity. For n-C₄H₁₀/iso-C₄H₁₀, the required percentage is even lower (8×10⁻⁸).

Coating materials that are much less permeable than PDMS must be used to effectively slow down Knudsen diffusion of hydrocarbons in fiber skin defects. Polyaramids can be conveniently formed in-situ on a hollow fiber surface, usually by reacting aromatic di/tri-amine and di/tri-acryl chloride monomers. Polyamide monomers are believed to be slim enough to diffuse into and polymerize inside smaller defects, providing small interstitial seals that cannot be realized by bulkier PDMS. Additionally, polyaramids are glassy polymers with rigid chains, and tend to be much less permeable than PDMS. Glassy polyaramid should be more effective than rubber PDMS to recover hydrocarbon selectivity of defective hollow fiber membranes.

To study polyaramid's effectiveness, the as-spun fibers were coated with a blend of PDMS and polyaramid following the procedure described in Example 4. PDMS was retained in the coating since it may be able to seal large-sized defects that in-situ polymerized polyaramid cannot entirely cover. The PDMS/polyaramid-coated fibers were tested for permeation and the results were compared with as-spun fibers and PDMS-coated fibers (Table 3). After the partially defective 30 wt % ZIF-8 loading mixed-matrix fiber was coated with PDMS/polyaramid, C₃H₆/C₃H₈ selectivity was dramatically enhanced from 16.4 to 27.5, which was −50% higher than the intrinsic value of the dense film (DAMZ_2). This suggested that polyaramid was indeed more effective than PDMS to recover the fiber's C₃H₆/C₃H₈ selectivity.

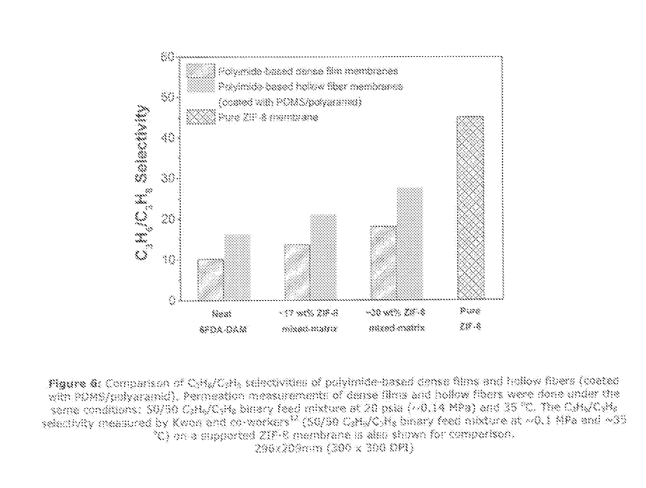

For comparison purposes, the as-spun neat 6FDA-DAM fiber and as-spun 17 wt % ZIF-8 loading mixed-matrix fiber were also coated by PDMS/polyaramid and tested for permeation. It should be noted that these fibers were close to being defect-free and polyaramid coating wasn't required to show selectivity consistent with dense films. As shown in Table 3, selectivities were again increased above the dense film value. This indicates that the polyaramid was intrinsically more selective than the underlying fiber. In any case, C₃H₆/C₃H₈ selectivity increased nicely with increasing ZIF-8 loading when comparing PDMS/polyaramid-coated fibers. This was consistent with the trend observed for dense films (FIG. 6) and suggested that adding ZIF-8 indeed enhanced C₃H₆/C₃H₈ selectivity of the hollow fiber membrane.

Due to strong hydrogen bonding, polyaramids are usually quite impermeable. The drastically reduced permeance of PDMS/polyaramid-coated fibers (Table 3) indicated that the particular polyaramid (based on DETDA and TMC) added substantial mass transfer resistance to permeation. That is to say, the chemistry of polyaramid and coating conditions must be adjusted so that membrane permeance is not significantly compromised.

### Example 8. Comparison of Dual-Layer ZIF-8/6FDA-DAM Mixed-Matrix Hollow Fiber Membranes with Supported ZIF-8 Membranes

To take advantage of ZIF-8's attractive molecular sieving properties for energy-efficient C₃H₆/C₃H₈ separation, an alternative to mixed-matrix membrane is a pure ZIF-8 membrane. Such membranes are usually formed by growing a continuous ZIF-8 layer atop a porous substrate (e.g. porous alumina) FIG. 6 shows the results of a recent study of a supported ZIF-8 membrane compared with the results of a study of ZIF-8-based mixed-matrix hollow fibers consistent with the present disclosure.

Compared with supported ZIF-8 membranes, ZIF-8-based mixed-matrix hollow fibers offer the advantage of superior scalability. At 30 wt % ZIF-8 loading, hollow fiber C₃H₆/C₃H₈ selectivity (27.5, Table 3) had started to approach supported ZIF-8 membranes. While C₃H₆ permeance of ZIF-8/6FDA-DAM mixed-matrix hollow fibers are much lower compared with supported ZIF-8 membranes, the difference can be potentially offset by the capability of hollow fiber module to provide much higher membrane area in a given volume. With further modification of composite hollow fiber spinning techniques, the currently discussed mixed-matrix approach is potentially able to economically deliver attractive C₃H₆/C₃H₈ separation efficiency that is at least competitive with supported ZIF-8 membranes. Formation of ultrahigh

ZIF-8 loading (>40 wt %) mixed-matrix hollow fiber membrane is under way and will be reported in our future work; however, many challenges remain to achieve defect-free performance under such high particle loading.

### Example 9. ZIF/CMS Hollo Fiber Membrane Preparation and Separation Properties

Carbon molecular sieve (CMS) hollow fiber membranes that were formed by pyrolysis of precursor ZIF-8/6FDA-DAM mixed-matrix hollow fiber membranes with 17 wt % ZIF-8 loading. The pyrolysis was done under purging of UHP Argon (200 sccm/min) using the following procedure:

1) 50° C. to 250° C. (13.3° C./min)
2) 250° C. to 485° C. (3.85° C./min)
3) 485° C. to 500° C. (0.25° C./min)
4) 500° C. 120 min soak
5) Cool down naturally

C₃H₆/C₃H₈ separation performance of the precursor mixed-matrix hollow fiber membrane and pyrolyzed mixed-matrix hollow fiber membrane was evaluated and is shown in Table 4. After the pyrolysis, propylene permeance increased from 2.4 to 98 GPU, while the propylene/propane separation factor decreased from 16.5 to 10.2. After four weeks of aging, however, propylene permeance decreased from 98 to 19.4 GPU, while the propylene/propane separation factor increased significantly from 10.2 to 30.8.

TABLE 4
C₃H₆/C₃H₈ separation performance of CMS hollow fiber membranes
pyrolyzed from precursor ZIF-8/6FDA-DAM mixed-matrix hollow
fiber membrane with 17 wt % ZIF-8 loading.

| Hollow fiber membrane | P(C₃H₆)/GPU | α(C₃H₆/C₃H₈) |
|---|---|---|
| Precursor ZIF-8/6FDA-DAM | 2.4 | 16.5 |
| CMS | 98 | 10.2 |
| CMS_aged for four weeks | 19.4 | 30.8 |

To facilitate an understanding of the principles and features of the various embodiments of the present invention, various illustrative embodiments are explained herein. Although exemplary embodiments of the present invention are explained in detail, it is to be understood that other embodiments are contemplated. Accordingly, it is not intended that the present invention is limited in its scope to the details of construction and arrangement of components set forth in the description or examples. The present invention is capable of other embodiments and of being practiced or carried out in various ways.

Also, in describing the exemplary embodiments, specific terminology will be resorted to for the sake of clarity. It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents that operate in a similar manner to accomplish a similar purpose.

As used herein, “substantially free” of something, or “substantially pure”, and like characterizations, can include both being “at least substantially free” of something, or “at least substantially pure”, and being “completely free” of something, or “completely pure.” By comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the present invention are intended to be illustrative and not restrictive. Many suitable materials that would perform the same or a similar function as the materials described herein are intended to be embraced within the scope of the present invention. Such other materials not described herein can include, but are not limited to, for example, materials that are developed after the time of the development of the present invention.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. A material comprising a hollow fiber comprising
a. a sheath layer, wherein the sheath layer comprises a plurality of metal organic framework (MOF) particles dispersed in a first polymer; and
b. a core layer adjacent to and radially inward from the sheath layer, wherein the core layer comprises a second polymer.

2. A material of claim 1, wherein the first and second polymers are the same polymer.

3. A material of claim 1, wherein the first and second polymers are different polymers.

4. A material of any of claims 1 to 3, wherein the first polymer is a polyimide.

5. A material of any of claims 1 to 4, wherein the core layer is substantially free of MOF particles.

6. A material of any of claims 1 to 5, wherein the MOF particles comprise MOF nanoparticles.

7. A material of any of claims 1 to 6, wherein the MOF particles comprise zeolitic imidazolate framework (ZIF) particles.

8. A material of claim 7, wherein the ZIF particles comprise ZIF-8 particles.

9. A material of any of claims 1 to 8, wherein the first polymer is 2,2-bis (3,4-carboxyphenyl) hexafluoropropane dianhydride-diaminomesitylene (6FDA-DAM).

10. A material of any of claims 1 to 9, wherein the sheath layer has a thickness of less than about 5 micron.

11. A material of claim 10, wherein the sheath layer has a thickness of about 1 to about 5 micron.

12. A material of any of claims 1 to 11, wherein the fiber has an outer diameter equal to or less than about 300 micron.

13. A material of claim 12, wherein the fiber has an outer diameter of about 150 to about 300 micron.

14. A material of any of claims 1-13, wherein the MOF particles are present in the sheath layer in an amount of at least 16% by weight.

15. A material of claim 14, wherein the MOF particles are present in the sheath layer in an amount of at least 20% by weight.

16. A method of forming a hollow fiber comprising
a. combining a first polymer, a plurality of MOF particles, and one or more solvents to form a sheath dope;
b. combining a second polymer and one or more solvents to form a core dope; and
c. co-extruding the sheath dope, the core dope, and a bore fluid through a spinneret to form a hollow fiber.

17. A method of claim 16, wherein the MOF particles comprise nanoparticles.

18. A method of claim 16 or 17, wherein the MOF particles are not dried prior to the step of forming the sheath dope.

19. A method of claim 16 or 17, wherein the step of combining the first polymer, the plurality of MOF particles, and one or more solvents to form a sheath dope comprises
a. dissolving a first portion of the first polymer in a first portion of a first solvent to form dope A;
b. combining MOF particles with a second portion of the first solvent to form a MOF/solvent slurry;
c. adding dope A to the MOF/solvent slurry to form dope B;
d. adding a second portion of the first polymer to dope B to form a paste;
e. adding a second solvent to the paste to form dope C;
f. adding a third portion of the first polymer to dope C to form the sheath dope.

20. A method of claim 19, wherein the MOF particles are not dried prior to the step of forming the MOF/solvent slurry.

21. A method of any of claims 16 to 20, wherein the MOF particles comprise ZIF particles.

22. A method of claim 21, wherein the ZIF particles comprise ZIF-8 particles.

23. A method of any of claims 16 to 22, wherein the first and second polymers are the same.

24. A method of any of claims 16 to 22, wherein the first and second polymers are different.

25. A method of any of claims 16 to 24, wherein the first polymer is a polyimide.

26. A method of any of claims 16 to 25, wherein the concentration of the first polymer in the sheath dope is about 20 to about 26% by weight.

27. A method of any of claims 16 to 26, wherein the concentration of MOF particles in the sheath dope is about 5 to about 9% by weight.

28. A method of any of claims 16 to 27, wherein the core dope further comprises lithium nitrate and the sheath dope does not comprise lithium nitrate.

29. A method of any of claims 16-28, further comprising coating the hollow fiber with a third polymer.

30. A method of claim 29, wherein the third polymer is a polyaramid.

31. A method of claim 29, wherein the third polymer is a polydimethylsiloxane.

32. A method of claim 29, wherein the third polymer is a mixture of a polyaramid and a polydimethylsiloxane.

33. A method of any of claims 16 to 32, wherein following co-extrusion the hollow fiber is quenched in a water bath at a temperature of from 12 to 50 degrees C.

34. A method of claim 33, wherein the water bath is at a temperature of 12 to 25 degrees C.

35. A method comprising separating a first component from a second component of a multicomponent mixture using a membrane comprising the material of claim 1.

36. A method of claim 35, wherein the first component comprises propylene and the second component comprises propane.

37. A method of claim 35, wherein the first component comprises carbon dioxide and the second component comprises methane.

38. A method of claim 35, wherein the first component comprises oxygen and the second component comprises nitrogen.

39. A method of claim 35, wherein the first component comprises ethylene and the second component comprises ethane.

40. A method of claim 35, wherein the first component comprises n-butane and the second component comprises iso-butane.

41. A material comprising a hollow fiber comprising
a. a sheath layer, wherein the sheath layer comprises a plurality of metal organic framework (MOF) particles dispersed in a first carbon molecular sieve having a first plurality of pores; and
b. a core layer adjacent to and radially inward from the sheath layer, wherein the core layer comprises a second carbon molecular sieve having a second plurality of pores.

42. A material of claim 41, wherein the first plurality of pores has an average pore size larger than the average pore size of the second plurality of pores.

43. A material of claim 41, wherein the first plurality of pores has an average pore size smaller than the average pore size of the second plurality of pores.

44. A material of any of claims 41 to 43, wherein the MOF particles comprise zeolitic imidazolate framework (ZIF) particles.

45. A material of claim 44, wherein the ZIF particles comprise ZIF-8 particles.

46. A material of any of claims 41-45, wherein the sheath layer has a thickness of less than about 5 micron.

47. A material of claim 46, wherein the sheath layer has a thickness of about 1 to about 5 micron.

48. A material of any of claims 41-47, wherein the fiber has an outer diameter equal to or less than about 300 micron.

49. A material of claim 48, wherein the fiber has an outer diameter of about 150 to about 300 micron.

50. A method of forming a hollow fiber comprising
a. heating a MOF polymer mixed-matrix hollow fiber from between about 19° C. and about 24° C. to between about 450° C. and about 650° C.;
b. holding the temperature of the fiber at the final temperature between about 450° C. and about 650° C.; and
c. cooling the fiber to between about 19° C. and about 24° C.

51. A method of claim 50, wherein the heating step is a one-step process.

52. A method of claim 50, wherein the heating step is a multi-step process, wherein each step includes heating at a different rate.

53. A method of any of claims 50 to 52, wherein each step is carried out under an inert gas.
